(19) United States
(12) Patent Application Publication
(10) Pub. No.: US 2005/0198826 A1
(43) Pub. Date: Sep. 15, 2005

(54) Shaving aid roller for razor cartridge

(76) Inventor: Geronimo Segrea, Oakville (CA)

Correspondence Address: GOWLING, LAFLEUR HENDERSON LLP, ONE MAIN STREET WEST, HAMILTON, ON, L8P 4Z5, CA

(21) Appl. No.: 10/795,361

(22) Filed: Mar. 9, 2004

(51) Int. Cl. B26B 19/42

(52) U.S. Cl. 30/41

(57) ABSTRACT

A razor blade cartridge is provided which incorporates at least one roller disposed adjacent to the shaving blades. The leading edge roller is finned to orient the hair for cutting and to lift and carry lubricant to the blades. The trailing edge roller has a smooth outer surface which rolls on the user's skin to minimize friction during shaving.

### FIELD OF INVENTION

The invention relates to a razor for cutting hair, usually facial hair, and for trimming hair to provide a neat, groomed appearance.

### BACKGROUND OF THE INVENTION

Many persons choose to shave body hair and will use different styles of shavers, razors and blades to achieve the desired effect. Razors are conveniently available in disposable models which can be discarded after the blades have been used and are no longer sharp enough to provide a close and comfortable shave. Some razors are also available with a more permanent blade holder in which the shaving head which contains the blades is disposed when no longer useful and replaced with a new shaving head or blade cartridge.

In order to improve shaving comfort, many razor blade cartridges are available which incorporate a shaving aid composite in the form of a lubricating strip. The lubricating strip may be water soluble to release a lubricating film upon wetting of the razor and may also be fabricated from water insoluble compounds designed to become slippery when wet without depositing a film on the shaver's skin during wet shaving. Two such razor cartridges incorporating a shaving aid are described in U.S. Pat. No. 6,301,785 and in U.S. Pat. No. 5,956,849. As shown in the aforementioned patents, the lubricating strips are often provided in pairs and disposed adjacent the shaving blades on opposite sides of the razor blade cartridge. In some cases, a finned elastomeric guard is provided on the leading end of the cartridge (ie. in front of the blades) and a single lubricating strip is provided on the trailing end of the cartridge (ie. behind the blades).

A problem which arises with the use of such shaving aids is that the lubricant supply is limited with the result that the razor blade cartridge can only be used three or four times before its advantages are lost.

An object of this invention is to provide a razor blade cartridge for use with disposable razors or with more permanent razor handles in which a more comfortable shave is provided for repeated usage over a longer period of time.

### SUMMARY OF THE INVENTION

In accordance with this invention, there is provided a razor blade cartridge having at least one blade disposed to extend transversely to a shaving direction and at least one roller disposed adjacent to said at least one blade for rotation in said shaving direction.

### BRIEF DESCRIPTION OF THE DRAWINGS

In order that the invention may be more clearly understood, a preferred embodiment of the invention is described below with reference to the accompanying drawings, in which:

FIG. 1 is a perspective view of a razor blade cartridge made in accordance with the invention;

FIG. 2(a) is a perspective view (drawn to a larger scale) of a roller included in the razor blade cartridge of FIG. 1;

FIG. 2(b) is a partially sectioned view of the roller of FIG. 2(a);

FIG. 3(a) is a perspective view (drawn to a larger scale) of a finned guard included in the razor blade cartridge of FIG. 1;

FIG. 3(b) is a partially sectional view of the finned guard of FIG. 3(a); and

FIG. 3(c) is an end view of the finned guard of FIG. 3(a).

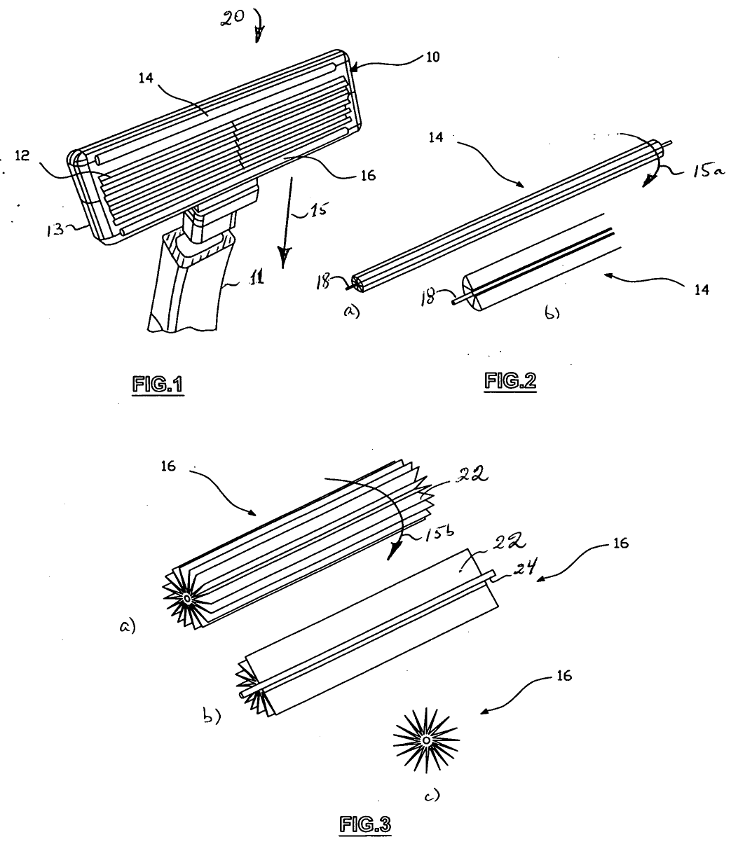

### DESCRIPTION OF PREFERRED EMBODIMENT WITH REFERENCE TO DRAWINGS

A razor assembly is generally indicated in the drawings by reference numeral 20 and consists of a razor blade cartridge 10 attached to a razor handle 11 of which only a portion is shown for illustration purposes only. The razor blade cartridge 10 includes a housing 13 which carries five blades 12 each disposed in parallel to each other and transverse to the handle 11 which generally corresponds to the shaving direction indicated by arrow 15.

A roller 14 is located in an opening (not shown) formed in the housing 13 at the trailing end of the razor blade cartridge 10 behind the blades 12 and extends parallel to the blades.

A second roller in the form of a finned guard 16 made of elastomeric material is located in an opening (not shown) formed in the housing 13 at the leading end of the razor blade cartridge 10 in front of the blades 12 and extends parallel to the blades.

The roller 14 is shown in more detail in FIG. 2. It will be seen that the roller 14 has a right circular cylindrical shape and a smooth outer surface which may optionally be formed from a plurality of segments as drawn. The material of construction for the roller 14 may be selected to comprise a water soluable or water insoluable lubricant or combinations of same. The roller 14 is mounted on a longitudinally extending pin shaft 18 having free ends which extend from opposite sides of the roller 14 for location in the housing 13 for the razor blade cartridge 10. The roller 14 is thereby adapted for rotation in the shaving direction indicated by arrows 15, 15a.

The finned guard 16 is shown in more detail in FIG. 3 and consists of a plurality of radially extending fins 22 of rectangular shape and disposed on a central longitudinally extending pin shaft 24 having free ends which extend from opposite sides of the finned guard for location in the housing 13 for the razor blade cartridge 10. The finned guard is thereby adapted for rotation in the shaving direction indicated by arrows 15, 15b.

In use, it will be understood that the finned guard 16 will be first to engage the the user's skin and that the fins 22 operate to lift the hair to present the hair in a favourable orientation for cutting by the blades 12. Further, by virtue of its rotation on the pin shaft 24, the finned guard 16 will lift and carry any lubricant from the user's skin such as soap or shaving gel so that the blades 12 are continuously lubricated during use.

The blades 12 will cut the hair and as the housing 13 pivots against the user's skin, the roller 14 engages the user's skin and rotates on the pin shaft 18. In this way, any friction between the razor and the user's skin is minimized for every stroke of the razor assembly 20 thereby improving shaving comfort, even where a lubricating coating has become depleted.

It will be understood that several variations may be made to the above-described preferred embodiment of the invention as will be apparent to those skilled in the art. In particular, it will be noted that the razor blade cartridge may have only a single roller 14, 16 or a pair of such rollers with both rollers having the configuration of the smooth roller 14. The material of construction for the rollers may be selected in accordance with the intended usage to take advantages of the benefits described in the prior art.

1. A razor blade cartridge having at least one blade disposed to extend transversely to a shaving direction and at least one roller disposed adjacent to said at least one blade for rotation in said shaving direction.

2. A razor blade cartridge according to claim 1 in which said at least one roller comprises lubricating material which is either water soluble or water insoluble or combinations of water soluble and water insoluble materials.

3. A razor blade cartridge according to claim 1 having a pair of said rollers disposed on opposite sides of the cartridge with said at least one blade disposed therebetween.

4. A razor blade cartridge according to claim 3 having a plurality of blades disposed between said rollers.

5. A razor blade cartridge according to claim 3 in which a leading edge roller is in the form of a finned guard having a plurality of radially extending fins for lifting hair and lifting and carrying lubricant toward said at least one blade.

6. A razor blade cartridge according to claim 3 in which a trailing edge roller is in the form of a right circular cylinder with a smooth outer surface.

7. A disposable razor having a razor blade cartridge coupled to a handle, the razor blade cartridge having at least one blade disposed to extend transversely to a shaving direction and at least one roller disposed adjacent to said at least one blade for rotation in said showing direction.

8. A disposable razor according to claim 7, in which the razor blade cartridge has at least one roller comprising lubricating material which is either water soluble or water insoluble or combinations of water soluble and water insoluble materials.

9. A disposable razor according to claim 7, the razor blade cartridge having a pair of said rollers disposed on opposite sides of the cartridge with said at least one blade disposed therebetween.

10. A disposable razor according to claim 9, the razor blade cartridge having a plurality of blades disposed between said rollers.

11. A disposable razor according to claim 9, the razor blade cartridge having a leading edge roller is in the form of a finned guard having a plurality of radially extending fins for lifting hair and lifting and carrying lubricant toward said at least one blades.

12. A disposable razor according to claim 9, the razor blade cartridge having a trailing edge roller in the form of a right circular cylinder with a smooth outer surface.
